(19) United States
(12) Patent Application Publication
(10) Pub. No.: US 2006/0093756 A1
(43) Pub. Date: May 4, 2006

(54) High-power dielectric seasoning for stable wafer-to-wafer thickness uniformity of dielectric CVD films

(76) Inventors: Nagarajan Rajagopalan, Santa Clara, CA (US); Li-Qun Xia, Santa Clara, CA (US); Mihaela Balseanu, Sunnyvale, CA (US); Thomas Nowak, Cupertino, CA (US); Ranjana Shah, Sunnyvale, CA (US); Huiwen Xu, Sunnyvale, CA (US); Chad Peterson, San Jose, CA (US); Derek R. Witty, Fremont, CA (US); Hichem M'Saad, Santa Clara, CA (US)

Correspondence Address: Applied Materials;Patent Counsel, Legal Affairs Department, P.O. Box 450A, Santa Clara, CA, 95052, US

(21) Appl. No.: 10/981,430

(22) Filed: Nov. 3, 2004

(51) Int. Cl. B05D 1/36

(52) U.S. Cl. 427/569; 427/402

(57) ABSTRACT

A method for seasoning a deposition chamber wherein the chamber components and walls are densely coated with a material that does not contain carbon prior to deposition of an organo-silicon material on a substrate. An optional carbon-containing layer may be deposited therebetween. A chamber cleaning method using low energy plasma and low pressure to remove residue from internal chamber surfaces is provided and may be combined with the seasoning process.

### BACKGROUND OF THE INVENTION

1. Field of the Invention

Embodiments of the present invention generally relate to the fabrication of integrated circuits. More particularly, embodiments of the invention relate to a method of seasoning the inside of a chamber and depositing a carbon-containing layer on substrates in the seasoned chamber.

2. Description of the Related Art

In the fabrication of integrated circuits and semiconductor devices, low-k materials such as carbides, e.g., silicon carbide, carbon doped oxides, e.g., carbon doped silicon oxide, and carbon doped nitrides, e.g., carbon doped silicon nitride, are typically deposited on a substrate in a processing chamber, such as a deposition chamber, e.g., a chemical vapor deposition (CVD) chamber. The deposition processes typically result in deposition of some of the material on the walls and components inside the deposition chamber. The residual material deposited on the chamber walls and components can affect the deposition rate from substrate to substrate and the uniformity of the deposition on the substrate. This residue can also detach from the chamber components and create contaminating particles that can damage or destroy semiconductor devices.

Particle contamination within the chamber is typically controlled by periodically cleaning the chamber using cleaning gases, typically fluorinated and/or oxygenated compounds, that are excited by inductively or capacitively coupled plasmas. Cleaning gases are selected based on their ability to bind the precursor gases and the deposited material formed on the chamber surfaces in order to form volatile products which can be exhausted from the chamber, thereby cleaning the process environment of the chamber.

Once the chamber has been sufficiently cleaned and the cleaning by-products have been exhausted out of the chamber, a seasoning step is typically performed to deposit a film onto internal components of the chamber forming the processing region to seal remaining contaminants therein. The deposited film reduces the contamination level during processing (by preventing residual particles adhered to the chamber components and walls from being dislodged and falling onto processing surfaces) and facilitates the chamber heating process. This step is usually carried out by depositing a seasoning film to coat the interior surfaces forming the processing region in accordance with the subsequent deposition process recipe.

Seasoning films are typically deposited using gas mixtures identical to those to be used in subsequent substrate processing. However, such carbon-containing gas mixtures have several drawbacks. For example, one or more internal chamber surfaces, such as the faceplate, is typically aluminum or aluminum based. Carbon-containing films tend to adhere strongly to these surfaces making them difficult to clean. Residual film particles adhering to chamber walls and components, especially the faceplate, even if covered by a seasoning layer, contribute to a lack of uniformity in substrate processing.

What is needed, therefore, is a chamber seasoning method to precede deposition of carbon-containing materials which does not include coating the internal chamber components and walls with a carbon-containing material. Such a method should also allow for convenient removal of the seasoning material during subsequent chamber cleaning processes.

### SUMMARY OF THE INVENTION

The present invention encompasses a method for seasoning a deposition chamber wherein one or more layers of one or more carbon-free materials are deposited on at least one internal surface of the chamber, and thereafter one or more layers of one or more organo-silicon materials are deposited on at least one substrate in the chamber. The present invention also encompasses a chamber cleaning method using low energy plasma and low pressure to remove residue from internal chamber surfaces.

In one embodiment, the seasoning method further entails depositing one or more layers of one or more carbon-containing materials over the carbon-free seasoning layer(s) before deposition of the organo-silicon layer(s). In another embodiment, the present invention encompasses a combination of the seasoning method and the cleaning method.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross-sectional view of an exemplary deposition chamber in which the present invention may be practiced.

FIG. 2 is a more detailed cross-sectional view of the gas distribution assembly and faceplate of FIG. 1.

FIG. 3 is a flow diagram describing the steps of one embodiment of the chamber cleaning process of the present invention.

### DETAILED DESCRIPTION

The present invention encompasses an improved deposition chamber seasoning method wherein the chamber components and walls are densely coated with a material that does not contain carbon. The chamber seasoning method of the present invention prevents carbon-containing deposition materials from contacting and adhering to the internal chamber surfaces. In addition, the seasoning film is easily cleaned with, e.g., fluorine radicals. Moreover, the facile removal of the underlying seasoning layer ameliorates the removal of the carbon-containing residue from seasoned surfaces such as the faceplate with, e.g., oxygen radicals. Improved cleaning of the internal chamber surfaces followed by dense, uniform seasoning thereof insures that substrates subsequently processed experience consistent deposition environments, which leads to better substrate-to-substrate uniformity.

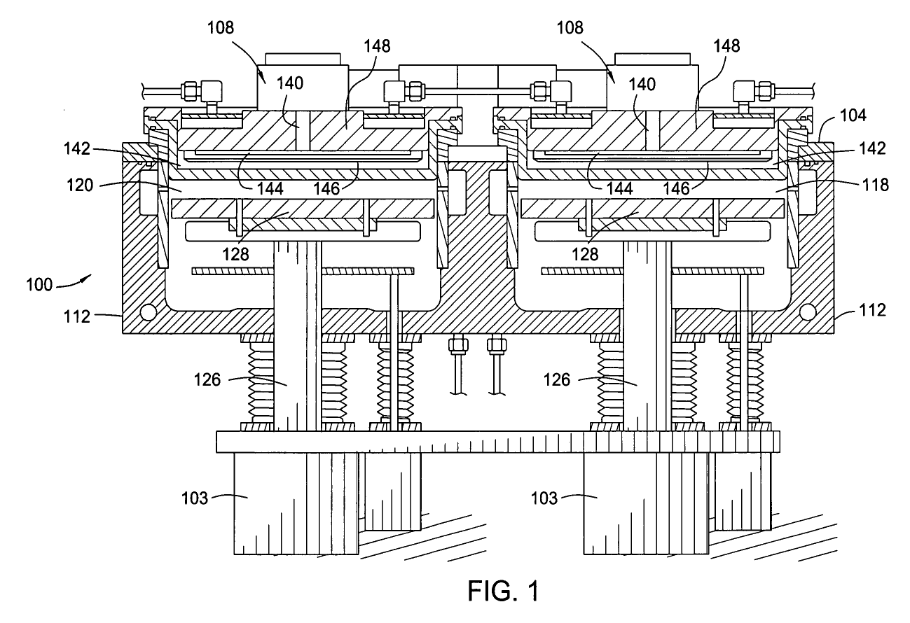

FIG. 1 shows a cross sectional view of a chamber 100, which is a Producer™ dual deposition station processing chamber available from Applied Materials, Inc. of Santa Clara, California. It is to be noted that other suitable processing chambers may be employed in practicing the present invention, and description thereof relating to a particular processing chamber is for illustrative purposes only. The chamber 100 has processing regions 118 and 120. A heater pedestal 128 is movably disposed in each processing region 118, 120 by a stem 126 which extends through the bottom of a chamber body 112 where it is connected to a drive system 103. Each of the processing regions 118, 120 also preferably include a gas distribution assembly 108 disposed through a chamber lid 104 to deliver gases into the processing regions 118, 120. The gas distribution assembly 108 of each processing region 118, 120 also includes a gas inlet passage 140 which delivers gas into a shower head assembly 142. The showerhead assembly 142 is comprised of an annular base plate 148 having a blocker plate 144 disposed intermediate a faceplate 146. A radio frequency (RF) feedthrough provides a bias potential to the showerhead assembly 142 to facilitate generation of a plasma between the faceplate 146 of the showerhead assembly 142 and the heater pedestal 128. Further details concerning chamber 100 are disclosed in commonly assigned U.S. patent application Ser. No. 10/247,404, entitled “Low Dielectric (Low k) Barrier Films With Oxygen Doping By Plasma-Enhanced Chemical Vapor Deposition (PECVD),” filed Sep. 19, 2002, which claims the benefit of U.S. Provisional Patent Application Ser. No. 60/397,184, filed Jul. 19, 2002, and is a continuation-in-part of U.S. patent application Ser. No. 10/196,498, filed Jul. 15, 2002, which claims the benefit of U.S. Provisional Patent Application Ser. No. 60/340,615, filed Dec. 14, 2001, all of which are herein incorporated by reference in their entirety to the extent not inconsistent herewith.

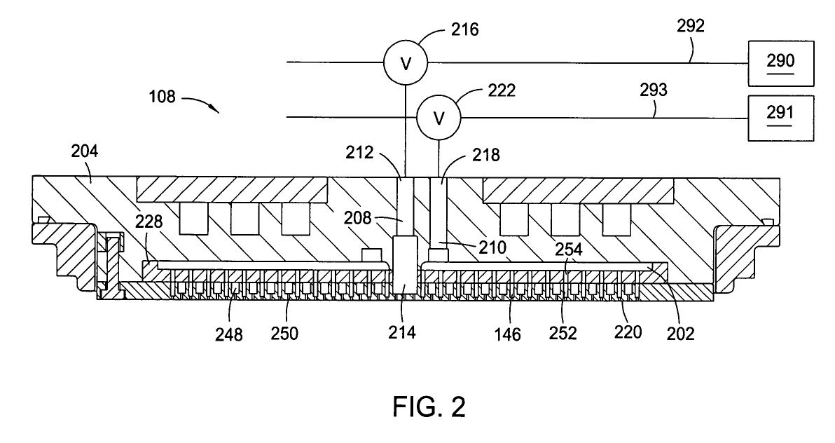

FIG. 2 depicts a more detailed view of the gas distribution assembly 108 and faceplate 146 shown in FIG. 1. The gas distribution assembly 108 is disposed at an upper portion of the chamber body 112 to provide two reactant gas flows distributed in a substantially uniform manner over a wafer (not shown). The two reactant gas flows are delivered in separate and discrete paths through the lid 104. Specifically, the lid 104 comprises a lid body 204 having a lower surface recess 228. A gas disperser 202 is disposed in the lower surface recess 228. A dual-channel faceplate 146 is positioned below the gas disperser 202. The lid 104 provides two gas flows through two discrete paths to processing regions 118, 120 defined between the faceplate 146 and a wafer (not shown) placed on a support plate (not shown) disposed on heater pedestal 128 (FIG. 1).

The gas disperser 202 has a plurality of holes 254 to accommodate a gas flow therethrough from a second gas channel 210 through a plurality of holes 252 in the faceplate 146 to the processing regions 118, 120. Similarly, the faceplate 146 has a plurality of grooves 248 that fluidly communicate with first gas outlet 214 and a plurality of holes 250 to accommodate a gas flow therethrough to the processing regions 118, 120.

The lid body 204 as used herein is defined as a gas manifold coupling gas sources to the chamber 100. The lid body 204 comprises a first gas channel 208 and a second gas channel 210 providing two separate paths for the flow of gases through the gas disperser 202. The first gas channel 208 comprises a first gas input 212 and a first gas outlet 214. The first gas input is adapted to receive a first gas from the first reactive gas source 290 (or a combination thereof and second reactive gas source 291) through valve 216. The first gas outlet 214 is adapted to deliver the first reactive gas to the top of the processing regions 118, 120. The second gas channel 210 of the lid body 204 comprises a second gas input 218 and a second gas outlet 220. The second gas input 218 is adapted to receive a second reactive gas from a second gas source 291 (or a combination thereof and first reactive gas source 290) through valve 222. The second gas outlet 220 is adapted to deliver the second gas to the processing regions 118, 120.

The term “gas” as used herein is intended to mean a single gas or a gas mixture. Gas sources as described above may be adapted to store and maintain a gas or liquid precursor in a cooled, heated, or ambient environment. The gas lines 292, 293 fluidly coupling the gas sources 290 and 291 to the gas inputs 212, 218 may also be heated, cooled, or maintained at ambient temperature. More specifically and in a preferred embodiment of the invention, reactive gas lines 292, 293 are heated to prevent condensation of a vaporized reactive gas. Further details regarding gas distribution assembly 108 and faceplate 146 are disclosed in commonly assigned U.S. patent Ser. No. 10/229,799, entitled “Tandem Wafer Processing System And Process,” (now abandoned), filed Aug. 27, 2002 which claims the benefit of U.S. Provisional Patent Application Ser. No. 60/380,943, filed May 16, 2002, both of which are herein incorporated by reference in their entirety to the extent not inconsistent herewith.

Deposition of films on substrates can be accomplished by processes such as chemical vapor deposition (CVD), low pressure chemical vapor deposition (LPCVD), plasma enhanced chemical vapor deposition (PECVD), high-density plasma chemical vapor deposition (HDP-CVD), and atomic layer deposition (ALD), among others. Such deposition processes are well known in the art and will not be described herein in significant detail. For illustrative purposes the present invention will be described with respect to a CVD process, however the invention is not so limited and may be applied to other deposition techniques. In one embodiment, a CVD chamber adapted to deposit an organo-silicon material on a substrate is plasma cleaned to remove residual material from internal chamber components. Typically, a chamber cleaning process entails the use of an etchant gas, such as one containing fluorine, to remove the deposited material from the chamber walls, faceplate, and other surfaces. In some processes, the etchant gas is introduced into the chamber and a plasma is formed so that the etchant gas reacts with and removes the deposited material from the chamber walls. Such cleaning procedures are commonly performed between deposition steps for every substrate processed or every n substrates processed.

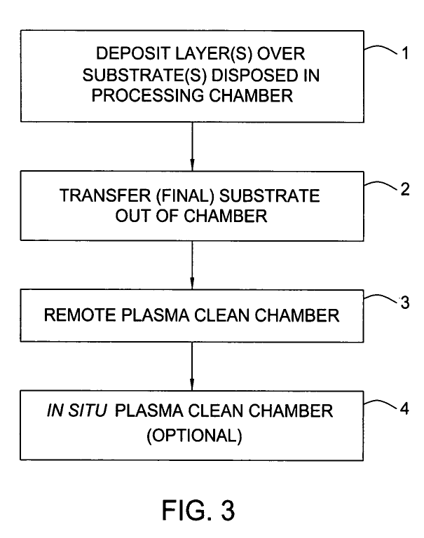

FIG. 3 is a flow chart depicting the steps according to one embodiment of a chamber cleaning process applicable to the present invention. As shown in FIG. 3, after a substrate deposition process or other type of substrate processing step (step 1) occurs in a substrate processing chamber, the (final) substrate is transferred out of the chamber (step 2). Next, an etchant gas is introduced into an appropriate remote plasma source where the gas is ionized to form a plurality of reactive, dissociated species, such as fluorine free radicals and other excited fluorine species. The reactive dissociated species are transported from the remote plasma chamber into the substrate processing chamber where they etch the unwanted deposition build-up to remove a first portion of residue from the chamber's interior as part of a first step of the chamber cleaning process (step 3).

Optionally, after a predetermined period of time, a plasma is then formed within the substrate processing chamber (an in situ plasma) from an appropriate etchant gas in order to complete the chamber cleaning process (step 4). The in situ plasma heats the chamber and is generally more effective at removing stubborn residue remnants than is remote plasma clean step 3 on a per unit volume of etchant gas basis. In some embodiments, the formation of the in situ plasma occurs concurrent with or shortly after the remote plasma is extinguished and the flow of etchant gas into the remote plasma source is stopped. In these embodiments, the in situ plasma etchant gas, which may be the same or a different etchant than the one used during the remote plasma clean step, is introduced directly into the substrate processing chamber from a gas source. In other embodiments, however, power to the remote plasma source is stopped while the flow of the etchant gas through the remote plasma cleaning system continues so that the etchant gas used in remote plasma clean step 3 is also the etchant gas used in in situ plasma clean step 4. Suitable etchant gases include, but are not limited to, NF₃ and F₂. In still other embodiments, an additional gas source, such an inert gas (e.g., argon or helium) or an oxygen-containing gas such as O₂ is introduced into the chamber along with the etchant gas in order to provide a sputtering element to the etch process thereby more rapidly heating the chamber to further improve the effectiveness of the process. Further details regarding deposition chamber cleaning are disclosed in commonly assigned U.S. patent application Ser. No. 10/187,817, entitled “Chamber Clean Method Using Remote and In Situ Plasma Cleaning Systems,” filed Jul. 1, 2002, which is herein incorporated by reference in its entirety to the extent not inconsistent herewith.

Embodiments of the present invention relate to an improved chamber cleaning process. In one aspect, lower power plasma excitation (˜100 W to ˜250 W) during the chamber cleaning process increases the etch rate and the etch rate uniformity of organo-silicon films, as shown in Table 1.

TABLE 1

| Power | | | Etch Rate | Etch Rate Uniformity |
|---|---|---|---|---|
| (RF) | Film | Conditions | (Å/Min) | (%) |
| 500 W | TEOS USG | RPS + IS | 10294 | 28.1 |
| 500 W | TEOS USG | RPS Only | 5238 | 36.5 |
| 150 W | TEOS USG | RPS + IS | 10806 | 26.4 |
| 150 W | TEOS USG | RPS Only | 8910 | 22.9 |
| 500 W | BLOk ™ | RPS + IS | 24932 | 24.8 |
| 500 W | BLOk ™ | RPS Only | 14477 | 37.8 |
| 150 W | BLOk ™ | RPS + IS | 23414 | 15.6 |
| 150 W | BLOk ™ | RPS Only | 20232 | 12.4 |

In this data, the films etched were tetraethoxysilane undoped silica glass (TEOS USG) and BLOk™, a proprietary organo-silicon material available from Applied Materials, Inc., of Santa Clara, Calif. The etching tests employed either remote plasma source excitation (RPS Only) (step 3 of FIG. 3), or remote plasma source followed by in situ plasma (RPS+IS) (steps 3 and 4 of FIG. 3). The in situ plasma energy was controlled at about 150 W. The etching tests were conducted utilizing NF₃ and O₂ for a period of 15 seconds. The etching rate was determined by using prepared substrates containing measured film thicknesses, and the etching rate uniformity was calculated using the 49 point polar map method entailing pre-clean and post-clean measurements, well known to those skilled in the art.

The data shown in Table 1 indicate that for the TEOS USG films, etching is more efficient (faster etch rate) when the in situ RF power is 150 W versus 500 W, and the etch rate uniformity similarly improves by using the lower RF power. The data relating to the BLOk™ etching is even more pronounced. The etch rate is dramatically increased and the etch rate uniformity is greatly improved by lower power etching. Additionally, it has been observed that lower power cleaning reduces the formation of aluminum fluoride (AlFₓ) species on internal chamber components comprising aluminum, such as the faceplate.

In another aspect, lower chamber pressure (˜3 Torr or less) during the chamber cleaning process increases the etch rate of organo-silicon films and etch rate uniformity of TEOS USG, as shown in Table 2.

TABLE 2

| | | | | Etch Rate |
|---|---|---|---|---|
| Pressure | | | Etch Rate | Uniformity |
| (Torr) | Film | Conditions | (Å/Min) | (%) |
| 2.0 | TEOS USG | RPS + 150 W IS | 5376 | 13.0 |
| 1.5 | TEOS USG | RPS + 150 W IS | 6700 | 5.5 |
| 2.0 | BLOk ™ | RPS + 150 W IS | 16210 | 23.0 |
| 1.5 | BLOk ™ | RPS + 150 W IS | 19028 | 23.5 |

The data shown in Table 2 indicate that for the TEOS USG and BLOk™ films, etching is more efficient when the chamber is maintained at a lower pressure during cleaning. Additionally, the etch rate uniformity of TEOS USG is greatly improved by lower pressure cleaning.

### EXAMPLE 1

In one embodiment of the chamber cleaning method of the present invention, the cleaning process is conducted as follows:
Step 1: Heat chamber to about 350° C. and commence flow of Ar
Step 2: Activate remote plasma source
Step 3: Commence flows of NF₃, O₂, and He
Step 4: Cease flow of Ar and activate in situ plasma source
Step 5: Cease flows of NF₃, O₂, and He, deactivate remote and in situ plasma sources, and evacuate chamber
   The flow of Ar is begun and maintained at about 1000 sccm for about 10 seconds before the remote plasma source is activated. The RPS is maintained for about 3 seconds before the flows of NF₃ (˜1000 sccm), O₂ (˜500 sccm), and He (˜1000 sccm) are begun. These flows of NF₃, O₂, and He are maintained for about 3 seconds before the Ar flow is stopped and the in situ plasma source is activated at a power of about 150 W. These RPS/IS cleaning conditions are maintained for about 80 seconds to about 300 seconds and then the flows of NF₃, O₂, and He are stopped, the remote and in situ plasma sources are deactivated, and the chamber is evacuated. Suitable cleaning times and conditions will vary and this cleaning sequence is merely illustrative of one embodiment of the present invention and other embodiments thereof are herein contemplated. In additional embodiments, the sequence of steps, times, temperatures, plasma power levels, etchant and carrier gases employed, and the flow rates thereof may be varied to more advantageously practice the invention in application thereof to other apparatus and/or carbon-containing films to be removed. Also, the chamber cleaning process of the present invention may be accomplished using only a remote plasma source excitation or only an in situ plasma source excitation.

Embodiments of the present invention also relate to an improved chamber seasoning process. Typically, if a chamber seasoning is employed prior to deposition of an organo-silicon film, a seasoning layer of the same organo-silicon material to be deposited during subsequent substrate processing is employed. However, organo-silicon materials are difficult to remove during subsequent cleaning procedures and longer cleaning cycles under harsher reaction conditions are required to thoroughly remove the seasoning layer and residual material deposited thereover.

Embodiments of the present invention entail seasoning a chamber by depositing a layer of carbon-free material on internal chamber surfaces prior to deposition of organo-silicon materials on substrates in the chamber. Generally this will entail deposition of the carbon-free material subsequent to a chamber cleaning procedure, as uniformity of the deposition environment during substrate processing is best ensured by providing a seasoning layer over clean chamber surfaces. As described in various embodiments of the present invention, the seasoning process described herein may be used to advantage in conjunction with deposition of organo-silicon materials onto a substrate. As described herein, organo-silicon materials include any substances containing silicon and carbon. The organo-silicon materials may comprise other substituents, such as, but not limited to, hydrogen, oxygen, and nitrogen. The organo-silicon films contemplated by the present invention may be deposited by any suitable method such as, but not limited to, CVD, LPCVD, PECVD, HDP-CVD, and ALD. Deposition of the organo-silicon films is typically onto glass substrates, but the applicability of the present invention is not so limited and embodiments thereof may be used to advantage in processes utilizing other substrate materials.

Embodiments of the present invention encompass the deposition of carbon-free materials onto internal surfaces of a deposition chamber. The carbon-free materials may contain silicon, and examples of such silicon-containing materials include, but are not limited to, silicon nitride, silicon oxide, silicon oxynitride, amorphous silicon, and combinations thereof. Herein, the term silicon nitride is used to describe any material consisting essentially of silicon, nitrogen, and optionally one or more halogens and/or hydrogen. Herein, the term silicon oxide is used to describe any material consisting essentially of silicon, oxygen, and optionally one or more halogens and/or hydrogen. Herein, the term silicon oxynitride is used to describe any material consisting essentially of silicon, oxygen, nitrogen, and optionally one or more halogens and/or hydrogen. Details relating to the deposition of silicon nitrides are disclosed in commonly assigned U.S. Pat. No. 5,399,387, entitled “Plasma CVD of Silicon Nitride Thin Films on Large Area Glass Substrates at High Deposition Rates,” commonly assigned U.S. Pat. No. 5,482,739, entitled “Silicon Nitride Deposition,” commonly assigned U.S. Pat. No. 6,372,291, entitled “In Situ Deposition and Integration of Silicon Nitride in a High Density Plasma Reactor,” and commonly assigned U.S. Pat. No. 6,534,424, entitled “Method of Forming Silicon Nitride on a Substrate,” all of which are herein incorporated by reference in their entirety to the extent not inconsistent herewith. Details relating to the deposition of silicon oxides are disclosed in commonly assigned U.S. Pat. No. 5,861,197, entitled “Deposition of High Quality Conformal Silicon Oxide Thin Films on Glass Substrates,” commonly assigned U.S. Pat. No. 6,596,653, entitled “Hydrogen Assisted Undoped Silicon Oxide Deposition Process for HDP-CVD,” commonly assigned U.S. Pat. No. 6,713,127, entitled “Methods for Silicon Oxide and Oxynitride Deposition Using Single Wafer Low Pressure CVD,” and commonly assigned U.S. Pat. No. 6,228,781, entitled “Sequential In-Situ Heating and Deposition of Halogen-Doped Silicon Oxide,” all of which are herein incorporated by reference in their entirety to the extent not inconsistent herewith. Details relating to the deposition of silicon oxynitrides are disclosed in commonly assigned U.S. patent application Ser. No. 10/288,538, entitled “Methods for Forming Silicon Comprising Films Using Hexachlorodisilane in a Single-Wafer Deposion Chamber,” filed Nov. 6, 2002, and commonly assigned U.S. patent application Ser. No. 10/040,583, entitled “Method and Apparatus for Forming Silicon Containing Films,” (now abandoned), filed Dec. 28, 2001, both of which are herein incorporated by reference in their entirety to the extent not inconsistent herewith. Details relating to the deposition of amorphous silicon are disclosed in commonly assigned U.S. Pat. No. 6,444,277, entitled “Method for Depositing Amorphous Silicon Thin Films onto Large Area Glass Substrates by Chemical Vapor Deposition at High Deposition Rates,” and commonly assigned U.S. Pat. No. 6,559,052, entitled “Deposition of Amorphous Silicon Films by High Density Plasma HDP-CVD at Low Temperatures,” both of which are herein incorporated by reference in their entirety to the extent not inconsistent herewith.

In various embodiments of the present invention, a method for seasoning a chamber entails exposing the inside of the chamber to a mixture of one or more carbon-free, silicon-containing compounds and one or more carbon-free, nitrogen-containing compounds in the presence of RF power to deposit a seasoning layer on one or more interior surfaces of the chamber. In one aspect, the seasoning process is carried out with no substrate in the deposition chamber. Preferably, however, a sacrificial (dummy) substrate is placed in the deposition chamber during the seasoning process. In addition, the seasoning may entail deposition of one or more layers. Further details regarding chamber seasoning are described in commonly assigned U.S. patent application Ser. No. 10/359,955, entitled “Method for Reduction of Contaminants in Amorphous-Silicon Film,” filed Feb. 6, 2003, which is a continuation-in-part of U.S. patent application Ser. No. 08/823,608, (now abandoned), filed Mar. 24, 1997, and commonly assigned U.S. Pat. No. 6,589,868, entitled “Si Seasoning to Reduce Particles, Extend Clean Frequency, Block Mobile Ions and Increase Chamber Throughput,” all of which are herein incorporated by reference in their entirety to the extent not inconsistent herewith.

### EXAMPLE 2

In one embodiment, a silicon nitride seasoning layer is deposited in a previously cleaned deposition chamber. A conventional CVD is carried out wherein SiH₄ and N₂ are provided to the chamber. The deposition chamber temperature is maintained at about 350° C. and the reactants are fed to the chamber for about 20 seconds. The RF power supplied to the chamber is about 850 to 1200 W, preferably from about 1000 to about 1200 W. Process details are as follows:
Step 1: Place substrate in chamber, heat chamber to about 350° C., and commence flow of N₂
Step 2: Activate in situ plasma source and commence flow of SiH₄
Step 3: Cease flows of N₂ and SiH₄, deactivate in situ plasma source, and evacuate chamber
   The flow of N₂ is begun and maintained at about 18000 sccm for about 10 seconds. Then, the in situ plasma source (˜1200 W) is activated and the flow of SiH₄ (˜320 sccm) is begun. These flows of N₂ and SiH₄ are maintained for about 20 seconds whereupon the flows of N₂ and SiH₄ are stopped, the in situ plasma source is deactivated, and the chamber is evacuated. This seasoning sequence is merely illustrative of one embodiment of the present invention and other embodiments thereof are herein contemplated. In additional embodiments, the sequence of steps, times, temperatures, plasma power level, reactants employed, and the flow rates thereof may be varied to more advantageously practice the invention in application thereof to other apparatus and/or carbon-containing films to be subsequently deposited and thereafter removed by chamber cleaning.

### EXAMPLE 3

In another embodiment, a conventional CVD is carried out wherein SiH₄, N₂, and NH₃ are provided to the chamber. The deposition chamber temperature is maintained at about 350° C. and the reactants are fed to the chamber for about 20 seconds. The RF power supplied to the chamber is about 850 to 1200 W, preferably from about 1000 to about 1200 W. Process details are as follows:
Step 1: Place substrate in chamber, heat chamber to about 350° C., and commence flows of N₂ and NH₃
Step 2: Activate in situ plasma source and commence flow of SiH₄
Step 3: Cease flows of N₂, NH₃, and SiH₄, deactivate in situ plasma source, and evacuate chamber
   The flow of N₂ is begun and maintained at about 18000 sccm for about 10 seconds. Then, the in situ plasma source (˜1200 W) is activated and the flow of SiH₄ (˜320 sccm) is begun. These flows of N₂, NH₃, and SiH₄ are maintained for about 20 seconds whereupon the flows of N₂, NH₃, and SiH₄ are stopped, the in situ plasma source is deactivated, and the chamber is evacuated.

One advantage obtained by seasoning a deposition chamber with a carbon-free, silicon-containing layer is that subsequent chamber cleanings may be accomplished more efficiently. During subsequent substrate processing wherein one or more organo-silicon materials are deposited in chamber, residue therefrom is more easily removed. Not to be bound by theory, it is believed that during a plasma chamber cleaning employing both fluorine and oxygen radicals, the fluoride radicals penetrate the residual organo-silicon layer and etch the underlying carbon-free, silicon-containing seasoning layer, thereby weakening the adhesion of the residual. organo-silicon material thereto. The organo-silicon residue is then etched by the oxygen radicals and more easily removed. This effect is most pronounced with respect to aluminum containing surfaces, such as the faceplate, within the chamber, as typically organo-silicon residues disposed thereon are difficult to remove.

Additionally, the carbon-free, silicon-containing seasoning layer acts as a glue layer in that the subsequently deposited organo-silicon materials tend to adhere thereto better than to the internal chamber surfaces. As such, residual organo-silicon deposition materials are less likely to become dislodged during substrate processing. In this manner less contamination is introduced into the processed substrates.

In a further embodiment of the invention, after a carbon-free, silicon-containing seasoning layer is deposited in a chamber, a carbon-containing seasoning layer is deposited thereover. As described above, the initial seasoning coats internal chamber components, and then a second seasoning wherein a material containing carbon is deposited onto the first seasoning layer is carried out. The carbon-containing seasoning layer may be formed from an organo-silicon material or any other carbon-containing material, such as, but not limited to, amorphous carbon, hydrogenated amorphous carbon, halogenated amorphous carbon, and combinations thereof. As described with regard to deposition of the carbon-free, silicon-containing seasoning layer, the carbon-containing seasoning layer may be deposited with or without a substrate disposed within the chamber. Additionally, the carbon-containing seasoning layer may be formed from one or more carbon-containing sources and may be deposited as a single layer or a composite of two or more layers. Further details regarding the deposition of organo-silicon materials are disclosed in commonly assigned U.S. patent application Ser. No. 10/655,276, entitled “Cluster Tool for E-Beam Treated Films,” filed Sep. 3, 2003, which is a continuation of U.S. patent application Ser. No. 10/428,374, entitled “Methods and Apparatus for E-Beam Treatment Used to Fabricate Integrated Circuit Devices,” filed May 1, 2003, which claims the benefit of U.S. Provisional Application No. 60/378,799, filed on May 8, 2002, all of which are herein incorporated by reference in their entirety to the extent not inconsistent herewith. Further details regarding the deposition of amorphous carbon are disclosed in commonly assigned U.S. Pat. No. 6,423,384, entitled “HDP-CVD Deposition of Low Dielectric Constant Amorphous Carbon Film,” which is herein incorporated by reference in its entirety to the extent not inconsistent herewith.

While the foregoing is directed to embodiments of the present invention, other and further embodiments of the invention may be devised without departing from the basic scope thereof, and the scope thereof is determined by the claims that follow.

1. A method for seasoning a deposition chamber comprising:
depositing one or more layers of one or more carbon-free materials on at least one internal surface of the chamber; then
transferring one or more substrates into the deposition chamber; and then
depositing one or more layers of one or more organo-silicon materials on at least one substrate in the chamber.

2. The method of claim 1, wherein the one or more carbon free materials comprise compounds selected from the group consisting of:
amorphous silicon;
silicon nitride;
silicon oxide;
silicon oxynitride; and
combinations thereof.

3. The method of claim 1, wherein at least one of the one or more carbon-free materials comprises silicon nitride.

4. The method of claim 1, wherein the one or more organo-silicon materials are deposited by plasma enhanced chemical vapor deposition.

5. The method of claim 1, wherein the depositing of one or more layers of one or more carbon-free materials on at least one internal surface of the chamber comprises plasma excitation, and the plasma is generated at an energy level of greater than about 1000 W.

6. The method of claim 1, further comprising:
depositing one or more carbon-containing materials on at least one surface onto which the one or more carbon-free materials have been deposited, prior to the transferring one or more substrates into the deposition chamber.

7. The method of claim 6, wherein the one or more carbon-containing materials comprise compounds selected from the group consisting of:
organo-silicon compounds;
amorphous carbon;
hydrogenated amorphous carbon;
halogenated amorphous carbon; and
combinations thereof.

8. A method for seasoning a deposition chamber comprising:
cleaning the chamber with a plasma;
depositing one or more layers of one or more carbon-free, silicon-containing materials on at least one internal surface of the chamber; and
depositing one or more layers of one or more organo-silicon materials on at least one substrate in the chamber.

9. The method of claim 8, wherein the plasma is generated in a location selected from the group consisting of:
the chamber;
remote to the chamber; and
a combination thereof.

10. The method of claim 8, wherein the plasma cleaning comprises introduction of one or more etchant gases comprising fluorine.

11. The method of claim 10, wherein at least one of the one or more etchant gases is NF₃.

12. The method of claim 8, wherein the plasma cleaning comprises introduction of an etchant gas comprising oxygen.

13. The method of claim 8, wherein the plasma is generated at an energy level of about 100 W to about 250 W.

14. The method of claim 8, wherein the plasma cleaning is carried out at a chamber pressure of less than about 3 Torr.

15. The method of claim 8, wherein at least one of the one or more carbon-free, silicon-containing materials comprises silicon nitride.

16. A method for cleaning a deposition chamber comprising:
providing one or more etchant gases to the chamber;
providing plasma excitation to at least one of the one or more etchant gases, wherein the plasma energy is generated at an energy level of about 100 W to about 250 W and the pressure in the chamber pressure is less than about 3 Torr.

17. The method of claim 16, wherein the plasma is generated in a location selected from the group consisting of:
the chamber;
remote to the chamber; and
a combination thereof.

18. The method of claim 16, wherein at least one of the one or more etchant gases comprises fluorine.

19. The method of claim 16, wherein at least one of the one or more etchant gases is NF₃.

20. The method of claim 16, wherein at least one of the one or more etchant gases comprises oxygen.
